(19) United States
(12) Patent Application Publication
(10) Pub. No.: US 2023/0206056 A1
(43) Pub. Date: Jun. 29, 2023

(54) FACTORIZING HYPERVECTORS

(71) Applicant: International Business Machines Corporation, Armonk, NY (US)

(72) Inventors: Michael Andreas Hersche, Zurich (CH); Kumudu Geethan Karunaratne, Gattikon (CH); Giovanni Cherubini, Rueschilkon (CH); Abu Sebastian, Adliswil (CH); Abbas Rahimi, Zurich (CH)

(21) Appl. No.: 17/564,277

(22) Filed: Dec. 29, 2021

(51) Int. Cl. G06N 3/08; G06V 10/74; G06V 10/82

(52) U.S. Cl. CPC G06N 3/08; G06V 10/761; G06V 10/82

(57) ABSTRACT

A computer-implemented method for factorizing hypervectors in a resonator network includes: receiving an input hypervector representing a data structure; performing an iterative process for each concept in a set of concepts associated with the data structure in order to factorize the input hypervector into a plurality of individual hypervectors representing the set of concepts, wherein the iterative process includes: generating a first estimate of an individual hypervector representing a concept in the set of concepts; generating a similarity vector indicating a similarity of the estimate of the individual hypervector with each candidate attribute hypervector of a plurality of candidate attribute hypervectors representing an attribute associated with the concept; and generating a second estimate of the individual hypervector based, at least in part, on a linear combination of the plurality of candidate attribute hypervectors and performing a non-linear function on the linear combination of the plurality of candidate attribute hypervectors.

### BACKGROUND OF THE INVENTION

The present invention relates to the field of digital computer systems, and more specifically, to a method for factorizing hypervectors in a resonator network.

Given a hypervector formed from an element-wise product of two or more atomic hypervectors (each from a fixed codebook), a resonator network may find its factors. The resonator network may iteratively search over the alternatives for each factor individually rather than all possible combinations until a set of factors is found that agrees with the input hypervector. The term “resonator network” as used herein may be defined in accordance with the following references: E. Paxon Frady et al. (“Resonator networks for factoring distributed representations of data structures,” Neural Computation 2020) and Spencer J. Kent et al. (“Resonator Networks outperform optimization methods at solving high-dimensional vector factorization,” Neural Computation 2020).

### SUMMARY

According to one embodiment of the present invention, a computer-implemented method for factorizing hypervectors in a resonator network is disclosed. The computer-implemented method includes receiving an input hypervector representing a data structure. The computer-implemented method further includes performing an iterative process for each concept in a set of concepts associated with the data structure in order to factorize the input hypervector into a plurality of individual hypervectors representing the set of concepts, respectively. The iterative process includes: generating a first estimate of an individual hypervector representing a concept in the set of concepts; generating a similarity vector indicating a similarity of the estimate of the individual hypervector representing the concept with each candidate attribute hypervector of a plurality of candidate attribute hypervectors representing an attribute associated with the concept; and generating a second estimate of the individual hypervector representing the concept in the set of concepts, wherein the second estimate of the individual hypervector is generated based, at least in part, on a linear combination of the plurality of candidate attribute hypervectors and performing a non-linear function on the linear combination of the plurality of candidate attribute hypervectors.

According to another embodiment of the present invention, a computer program product for factorizing hypervectors in a resonator network is disclosed. The computer program product includes one or more computer readable storage media and program instructions stored on the one or more computer readable storage media. The program instructions include instructions to receive an input hypervector representing a data structure. The program instructions further include instructions to perform an iterative process for each concept in a set of concepts associated with the data structure in order to factorize the input hypervector into a plurality of individual hypervectors representing the set of concepts, respectively. The iterative process includes program instructions to: generate a first estimate of an individual hypervector representing a concept in the set of concepts; generate a similarity vector indicating a similarity of the estimate of the individual hypervector representing the concept with each candidate attribute hypervector of a plurality of candidate attribute hypervectors representing an attribute associated with the concept; and generate a second estimate of the individual hypervector representing the concept in the set of concepts, wherein the second estimate of the individual hypervector is generated based, at least in part, on a linear combination of the plurality of candidate attribute hypervectors and performing a non-linear function on the linear combination of the plurality of candidate attribute hypervectors.

According to another embodiment of the present invention, a computer system for factorizing hypervectors in a resonator network is disclosed. The computer system includes one or more computer system includes one or more computer processors, one or more computer readable storage media, and program instructions stored on the computer readable storage media for execution by at least one of the one or more processors. The program instructions include instructions to receive an input hypervector representing a data structure. The program instructions further include instructions to perform an iterative process for each concept in a set of concepts associated with the data structure in order to factorize the input hypervector into a plurality of individual hypervectors representing the set of concepts, respectively. The iterative process includes program instructions to: generate a first estimate of an individual hypervector representing a concept in the set of concepts; generate a similarity vector indicating a similarity of the estimate of the individual hypervector representing the concept with each candidate attribute hypervector of a plurality of candidate attribute hypervectors representing an attribute associated with the concept; and generate a second estimate of the individual hypervector representing the concept in the set of concepts, wherein the second estimate of the individual hypervector is generated based, at least in part, on a linear combination of the plurality of candidate attribute hypervectors and performing a non-linear function on the linear combination of the plurality of candidate attribute hypervectors.

### BRIEF DESCRIPTION OF THE DRAWINGS

The following detailed description, given by way of example and not intend to limit the disclosure solely thereto, will best be appreciated in conjunction with the accompanying drawings, in which:

FIG. 1 is a functional block diagram of a resonator network computing environment, generally designated 100, in accordance with at least one embodiment of the present invention.

FIG. 2 is a functional block diagram of a resonator network computing environment, generally designated 200, in accordance with at least one embodiment of the present invention.

FIG. 3 is a functional block diagram of a resonator network computing environment, generally designated 300, in accordance with at least one embodiment of the present invention.

FIG. 4A is a graph illustrating the accuracy of a resonator network using a top-k sparsification method, generally designated 401, in accordance with at least one embodiment of the present invention.

FIG. 4B is a graph illustrating the number of iterations required by a resonator network using a top-k sparsification method, generally designated 410, in accordance with at least one embodiment of the present invention.

FIG. 4C is a graph illustrating the accuracy of a resonator network using a mean-based thresholding method, generally designated 420, in accordance with at least one embodiment of the present invention.

FIG. 4D is a graph illustrating the number of iterations required by a resonator network using a mean-based thresholding method, generally designated 430, in accordance with at least one embodiment of the present invention.

FIG. 4E is a graph illustrating noise resiliency and accuracy of: a resonator network using a top-k sparsification method, a resonator using a mean-based thresholding method, and a resonator network that does not use a sparsification method, generally designated 440, in accordance with at least one embodiment of the present invention.

FIG. 5 is a flow chart diagram depicting operations steps for factorizing a hypervector in accordance with at least one embodiment of the present invention.

FIG. 6 is a block diagram depicting components of an exemplary computing device, generally designated 600, operational with a resonator computing network, in accordance with at least one embodiment of the present invention.

FIG. 7 is a block diagram depicting a cloud computing environment 50 in accordance with at least one embodiment of the present invention.

FIG. 8 is a block diagram of a set of functional abstraction model layers provided by cloud computing environment 50 depicted in FIG. 7 in accordance with at least one embodiment of the present invention.

### DETAILED DESCRIPTION

The present invention relates to the field of digital computer systems, and more specifically, to a method for factorizing hypervectors in a resonator network.

Data structures can be employed to represent cognitive concepts, such as colors, shapes, positions, etc. Each cognitive concept may comprise multiple different items or attributes (e.g., attributes of the color concept may comprise red, green, blue etc). The data structure may contain a combination (e.g., product) of multiple components each representing a cognitive concept. For example, the data structure may be an image of a red circle in the bottom right portion of the image and a green rectangle in the top left portion of the image. Here, the cognitive concepts are the shapes (circle and rectangle, respectively), the color of the shapes (red and green, respectively) and the position of the shapes (bottom right and top left portions of the image, respectively). In another example, a data structure may form a distributed representation of a tree, wherein each leaf in the tree may represent a concept, and each type of traversal operations in the tree may represent different items or attributes.

In an embodiment, the data structure may be encoded by an encoder into a hypervector that uniquely represents the data structure. A hypervector may be a vector of bits, integers, real or complex numbers. The hypervector is a vector having a dimension higher than a minimum dimension (e.g., 100). In an embodiment, the hypervector may be holographic with independent and identically distributed (i.i.d) components. The hypervector being holographic means that each bit position in the hypervector may have an equal weight, in contrast to a conventional model with most significant bits and least significant bits. In an embodiment, the encoder may combine hypervectors that represent individual concepts with operations to represent a data structure. For example, the above-mentioned image may be described as a combination of multiplication (or binding) and addition (or superposition) operations as follows: (bottom right*red*disk)+(top left*green*rectangle). In an embodiment, the encoder may represent the image using hypervectors that in turn represent the individual concepts and the operations to obtain the representation of the image as a single hypervector that distinctively represents the knowledge that the disk is red and placed at the bottom right and the rectangle is green and placed at the top left.

In an embodiment, the encoder may be defined by a vector space of a set of hypervectors which encode a set of cognitive concepts and algebraic operations on the set of hypervectors. The algebraic operations may, for example, comprise a superposition operation and a binding operation. In addition, the algebraic operations may comprise a permutation operation. The vector space may, for example, be a D-dimensional space, where D>100. The hypervector may be a D-dimensional vector comprising D numbers that define the coordinates of a point in the vector space. The D -dimensional hypervectors may be in {−1, +1}^{D} and thus may be referred to as “bipolar.” For example, a hypervector may be understood as a line drawn from the origin to the coordinates specified by the hypervector. The length of the line may be the hypervector' s magnitude. The direction of the hypervector may encode the meaning of the representation. The similarity in meaning may be measured by the size of the angles between hypervectors. This may typically be quantified as a dot product between hypervectors.

In an embodiment, the encoder may be a decomposable (i.e., factored) model to represent the data structures. This may be advantageous as the access to the hypervectors may be decomposed into the primitive or atomic hypervectors that represent the individual items of the concepts in the data structure. For example, the encoder may use a Vector Symbolic Architecture (VSA) technique to represent the data structure by a hypervector. The encoder may, for example, comprise a trained feed-forward neural network.

Hence, in an embodiment, the encoding of data structures may be based on a predefined set of F concepts, where F >1 and candidate items that belong to each of the F concepts. Each candidate item may be represented by a respective hypervector. Each concept may be represented by a matrix of the hypervectors representing candidate items of the concept, e.g., each column of the matrix may be a distinct hypervector. As used herein, the matrix may be referred to as codebook and the hypervector representing one item of the concept may be referred to as a code hypervector. The components of the code hypervector may, for example, be randomly chosen. For example, a codebook representing the concept “color” may comprise seven possible colors as candidate items, a codebook representing the concept “shapes” may comprise twenty-six possible shapes as candidate items etc. Thus, each codebook i may comprise a set of Mᵢ code hypervectors.

Embodiments of the present invention recognize that querying such data structures through their hypervector representations may require decoding the hypervectors. Although decoding such hypervectors may be performed by testing every combination of code hypervectors, this process can be resource intensive. Embodiments of the present invention improve upon current methods of querying data structures through their hypervector representations and reduce computing resources consumed thereof by utilizing a resonator network. In particular, the resonator network can efficiently decode a given hypervector without needing to directly test every combination of factors. This stems from the fact that the superposition operation is used for encoding of multiple concept items in the given hypervector, as well the fact that randomized code hypervectors may be highly likely to be close to orthogonal in the vector space, meaning that they can be superposed without much interference. In an embodiment, the resonator network may search for possible factorizations of the given hypervector by combining a strategy of superposition and clean-up memory. The clean-up memory may reduce some crosstalk noise between the superposed concept items. In an embodiment, the resonator network combines the strategy of superposition and clean-up memory to efficiently search over the combinatorially large space of possible factorizations. In an embodiment, the resonator network may be an iterative approach.

In an embodiment, it is assumed for a simplified description of the iterative process of the resonator network that the set of concepts comprises three concepts i.e., F=3. However, embodiments of the present invention can be practiced utilizing less than or greater than three concepts. The codebooks/matrices representing the set of concepts may be referred to as X, Y and Z respectively. In an embodiment, the codebook X may comprise Mₓ code hypervectors xᵢ . . . x_{M}_{ₓ}. In an embodiment, the codebook Y may comprise M_{y} code hypervectors yⱼ . . . y_{M}_{_{y}}. In an embodiment, the codebook Z may comprise M_{z} code hypervectors zₖ . . . z_{M}_{_{z}}. This may define a search space of size M=Mₓ·M_{y}·M_{z}. Thus, given a hypervector s that represents a data structure and given the set of predefined concepts, an initialization may be performed by initializing an estimate of the hypervector that represents each concept of the set of concepts as a superposition of all candidate code hypervectors of said concept e.g., \hat{x}(0)=sign(Σ_{i=1, . . . , M}_{ₓ}xᵢ, ŷ(0)=sign(Σ_{j=1, . . . , M}_{_{y}}yⱼ) and \hat{z}(0)=sign(Σ_{k=1, . . . , M}_{_{z}}zₖ). Here, the term “estimate of a hypervector u” refers to a hypervector of the same size as hypervector u.

In an embodiment, for each current iteration t, the following may be performed. A first estimate \tilde{x}(t), \tilde{y}(t) and \tilde{z}(t) of the hypervector that represents each concept of the set of concepts may be inferred from the hypervector s based on the estimates of hypervectors for the other remaining F−1 concepts of the set of concepts e.g. \tilde{x}(t)=s⊙\tilde{y}(t)⊙\hat{z}(t)), \tilde{y}(t)=s⊙\hat{x}(t)⊙\hat{z}(t)) and \tilde{z}(t)=s⊙\hat{x}(t)⊙ŷ(t), where ⊙ refers to elementwise multiplication. This may be referred to as an inference step. The inference step may, however, be noisy if many estimates (e.g., F−1 is high) are tested simultaneously. The first estimates \tilde{x}(t), \tilde{y}(t) and \tilde{z}(t) may be noisy. This noise may result from crosstalk of many quasi-orthogonal code hypervectors, and may be reduced through a clean-up memory. In an embodiment, the clean-up memory may be built from the codebooks X, Y and Z, which contain all the code hypervectors that are possible factors of the inputs.

In an embodiment, after providing the first estimate of a hypervector of a given concept, the clean-up memory may be used to find the similarity of each code hypervector of the given concept to the first estimate of the hypervector. This may be referred to as a similarity step. The similarity of each code hypervector of the given concept may be computed as a dot product of the codebook that represents the given concept by the first estimate of the hypervector, resulting in a similarity vector aₓ(t), a_{y}(t) and a_{z}(t), respectively. The similarity vectors aₓ(t), a_{y}(t) and a_{z}(t) have sizes Mₓ, M_{y} and M_{z}, respectively, and may be obtained as follows: aₓ(t)=X^{T} \tilde{x}(t)∈ [symbol] ^{M}^{ₓ}, a_{y}(t)=Y^{T}\tilde{y}(t)∈ [symbol] ^{M}^{_{y}} and a_{z}(t)=Z^{T}\tilde{z}(t)∈ [symbol] ^{M}^{_{z}}. For example, after providing the first estimate hypervector \tilde{z}(t), the clean-up memory may be used to identify the code hypervector of the concept Z that is most similar to the first estimate hypervector \tilde{z}(t). For that, the similarity of the first estimate hypervector \tilde{z}(t) to each of the candidate code hypervectors of the corresponding codebook Z may be computed by multiplying the hypervector \tilde{z}(t) by the matrix Z^{T} (i.e., Z^{T} \tilde{z}(t) , where Z^{T} is the transpose of the matrix Z) which is stored in the clean-up memory, to obtain the similarity vector a_{z}(t). The smallest element of a_{z}(t) indicates the code hypervector which best matches the first estimate \tilde{z}(t).

In an embodiment, after computing the F similarity vectors associated with the set of concepts respectively, the similarity vectors may be sparsified according to at least one embodiment of the present invention. In an embodiment, sparsification of the similarity vector may be performed by activating a portion of the elements of the similarity vector and deactivating the remaining portion of the elements of the similarity vector. Activating an element of the similarity vector means that the element may be used or considered when an operation is performed on the similarity vector. Deactivating an element of the similarity vector means that the element may not be used or considered when an operation is performed on the similarity vector. For that, an activation function named kact may be used to activate a portion of elements as follows: a′ₓ(t)=kact(aₓ(t)), a′_{y}(t)=kact(a_{y}(t)) and a′_{z}(t)=kact(a_{z}(t)).

In a first embodiment, the activation function kact may only activate the top K absolute values in each of the similarity vectors aₓ(t), a_{y}(t) and a_{z}(t), where K<<M_{z}, and deactivate the rest of the elements by setting them to a given value (e.g., zero to produce a′ₓ(t), a′_{y}(t) and a′_{z}(t) respectively). The top K values of a similarity vector may be obtained by sorting the absolute values of the similarity vector and selecting the K first ranked values. The activation itself keeps the sign information, meaning that the modified similarity vectors a′ₓ(t), a′_{y}(t) and a′_{z}(t) comprise the signed values. K may, for example, be a configurable parameter whose value may change (e.g., depending on available resources).

In a second embodiment, the activation function kact may activate each element in each of the of the similarity vectors aₓ(t), a_{y}(t) and a_{z}(t) only if is absolute value is larger than a mean of all elements of the respective similarity vector. The mean is determined using the absolute values of the similarity vector. The activation itself keeps the sign information, meaning that the modified similarity vectors a′ₓ(t), a′_{y}(t) and a′_{z}(t) comprise the signed values.

The modified similarity vectors a′ₓ(t), a′_{y}(t) and a′_{z}(t) may be the output of the similarity step in accordance with at least one embodiment of the present invention. In an embodiment, after obtaining the modified similarity vectors a′ₓ(t), a′_{y}(t) and a′_{z}(t), a weighted superposition of the modified similarity vectors a′ₓ(t), a′_{y}(t) and a′_{z}(t) may be performed and followed by the application of a non-linear function g. This may be referred to as the superposition step. In an embodiment, the superposition step may be performed on the modified similarity vectors a′ₓ(t), a′_{y}(t) and a′_{z}(t) as follows: \hat{x}(t+1)= [symbol] (Za′ₓ(t)), ŷ(t+1)= [symbol] (Za′_{y}(t)) and \hat{z}(t+1)= [symbol] (Za′_{z}(t)), respectively, in order to obtain the current estimates \hat{x}(t+1), ŷ(t+1) and \hat{z}(t+1), respectively, of the hypervectors that represent the set of concepts. In other words, the superposition step generates each of the estimates \hat{x}(t+1), ŷ(t+1) and \hat{z}(t+1) representing the respective concept by a linear combination of the candidate code hypervectors (provided in respective matrices X, Y and Z), with weights given by the respective sparsified similarity vectors a′ₓ(t), a′_{y}(t) and a′_{z}(t), followed by the application of the non-linear function [symbol] . The weights given by the sparsified similarity vector are the values of the sparsified similarity vector. Hence, the current estimates of the hypervectors representing the set of concepts respectively may be defined as follows \hat{x}(t+1)=g(Xkact(X^{T} (s⊙ŷ(t)⊙\hat{z}(t)))), ŷ(t+1)=g(Ykact(Y^{T} (s⊙\hat{x}(t)⊙\hat{z}(t)))) and \hat{z}(t+1)=g(Zkact(Z^{T} (s⊙\hat{x}(t)⊙ŷ(t)))) where g is the non-linear function, for example a sign function.

The sparsification method according to at least one embodiment of the present invention results in doing only a part of vector multiplication-addition operations instead of all Mᵢ operations, which ultimately results in the amount of computing resources consumed when compared to current methods of querying data structures through their hypervector representations. The sparsification method according to the first embodiment may reduce the amount of computations, increase the size of solvable problems by an order of magnitude at a fixed vector dimension, and improve the robustness against noisy input vectors. The sparsification method according to the second embodiment may improve the computational complexity of the first embodiment by removing the sort operation needed to find the top-k elements.

Accordingly, embodiments of the present invention efficiently factorize the hypervector representing a data structure into the primitives from which it is composed. For example, given a hypervector formed from an element-wise product of two or more hypervectors, its factors (i.e., the two or more hypervectors) can be efficiently found. As such, a nearest-neighbour lookup may need only search over the alternatives for each factor individually rather than all possible combinations. This may reduce the number of operations involved in every iteration of the resonator network and hence reduce the complexity of execution. This may also solve larger size problems (at fixed dimensions) and improve the robustness against noisy input hypervectors.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

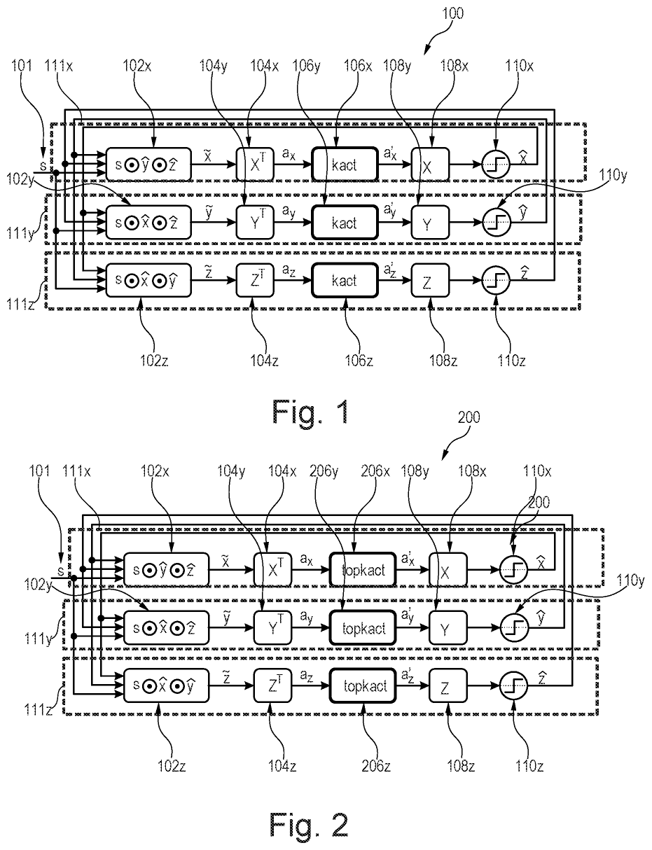

The present invention will now be described in detail with reference to the Figures. FIG. 1 is a functional block diagram of a resonator network computing environment, generally designated 100, in accordance with at least one embodiment of the present invention. For simplicity purposes, resonator network computing environment 100 is configured to execute a resonator network to decode hypervectors that are encoded in a vector space defined by three concepts. However, resonator network computing environment may be configured to execute a resonator network to decode hypervectors that are encoded in a vector space defined by less than or greater than three concepts. The codebooks representing the set of concepts may be referred to as X, Y and Z respectively. The codebook X may comprise Mₓ code hypervectors xᵢ . . . x_{M}_{ₓ}. The codebook Y may comprise M_{y} code hypervectors yⱼ . . . y_{M}_{_{y}}. The codebook Z may comprise M_{z} code hypervectors zₖ . . . z_{M}_{_{z}}. This may define a search space of size M=Mₓ·M_{y}·M. The resonator network may, for example, be a recurrent neural network.

Resonator network computing system 100 includes network nodes 102x, 102y and 102z that represent the three concepts, respectively. Resonator network computer environment 100 further includes memories 104x, 104y and 104z for storing the codebooks X^{T}, Y^{T} and Z^{T} respectively. Resonator network computing system 100 further includes memories 108x, 108y and 108z for storing the transposes X, Y and Z of the codebooks respectively. Resonator network computing system 100 further includes activation units 106x, 106y and 106z for each of the three concepts that implement the activation function kact according to at least one embodiment of the present invention. Resonator network computing environment 100 further includes non-linear units 110x, 110y and 110z for each of the three concepts that implement the sign function. As indicated in FIG. 1-FIG. 3, the concepts of the vector space may be associated with processing lines 111x, 111y and 111z respectively, wherein each processing line provides an estimate of a hypervector representing the respective concept (e.g., processing line 111x provides estimates \hat{x}, processing line 111y provides estimates ŷ, and processing line 111z provides estimates \hat{z}.)

In an embodiment, an input hypervector 101 named s is received by resonator network computing environment 100. The input hypervector s may be the result of encoding a data structure such as a coloured image comprising MNIST digits. The encoding may be performed by a VSA technique. At t=0, the resonator network computing environment 100 initializes an estimate of the hypervector that represents each concept of the set of concepts as a superposition of all candidate code hypervectors of said concept as follows: \hat{x}(0)=sign(Σ_{i=1, . . . ,M}_{ₓ}xᵢ), ŷ(0)=sign(Σ_{i=1, . . . ,M}_{_{y}}yⱼand \hat{z}(0)=sign(ΣE_{k=1, . . . ,M}_{_{z}}zₖ).

The operation of the resonator network system 100 may be described for a current iteration t. In an embodiment, network nodes 102x, 102y, and 102z receive simultaneously or substantially simultaneously the respective triplet (s,ŷ(t),\hat{z}(t)), (s,\hat{x}(t),\hat{z}(t)) and (s,\hat{x},ŷ(t)). In an embodiment, the three network nodes may compute the first estimates \tilde{x}(t), \tilde{y}(t) and \tilde{z}(t) of the hypervectors that represent the set of concepts respectively as follows: \tilde{x}(t)=s⊙ŷ(t)⊙\hat{z}(t), \tilde{y}(t)=s⊙\hat{x}(t)⊙\hat{z}(t) and \tilde{z}(t)=s⊙\hat{x}(t)⊙ŷ(t), where ⊙ refers to elementwise multiplication. This may be referred to as an inference step. That is, the nodes may perform the inference step on respective input triplets.

In an embodiment, the similarity of the first estimate \tilde{x}(t) with each of the Mₓ code hypervectors xᵢ . . . x_{M}_{ₓ} is computed using the codebook X stored in memory 104x as follows: aₓ(t)=X^{T} \tilde{x}(t)∉ [symbol] ^{M}^{ₓ} for multiplying the hypervector \tilde{x}(t) by the matrix X^{T}. In an embodiment, the similarity of the first estimate \tilde{y}(t) with each of the M_{y} code hypervectors yⱼ . . . y_{M}_{_{y}} is computed using the codebook Y stored in memory 104y as follows: a_{y}(t)=Y^{T} \tilde{y}(t)∈ [symbol] ^{M}^{_{y}} for multiplying the hypervector \tilde{y}(t) by the matrix Y^{T}. In an embodiment, the similarity of the first estimate \tilde{z}(t) with each of the M_{z} code hypervectors zₖ . . . z_{M}_{_{z}} is computed using the codebook Z stored in memory 104z as follows: a_{z}(t)=Z^{T} \tilde{z}(t)∈ [symbol] ^{M}^{_{z}} multiplying the hypervector \tilde{z}(t) by the matrix Z^{T}. The resulting vectors aₓ(t), a_{y}(t) and a_{z}(t) may be named similarity vectors or attention vectors. The largest element of each of the similarity vectors aₓ(t), a_{y}(t) and a_{z}(t) indicates the code hypervector which matches best the first estimate \tilde{x}(t), \tilde{y}(t) and \tilde{z}(t) respectively.

In an embodiment, after computing the similarity vectors, the similarity vectors aₓ(t), a_{y}(t) and a_{z}(t) are sparsified using the activation function kact implemented by activation units 106x, 106y and 106z respectively. In an embodiment, the sparsification of the similarity vector is performed by activating a portion of the elements of the similarity vector. For that, the activation function kact may be used to activate said portion of elements as follows: a′ₓ(t)=kact(aₓ(t)), a′_{y}(t)=kact(a_{y}(t)) and a′_{z}(t)=kact(a_{z}(t)). The modified similarity vectors a′ₓ(t), a′_{y}(t) and a′_{z}(t) may be the output of the similarity step in accordance with the present subject matter. Thus, for each concept of the set of concepts, the similarity step may receive as input the respective one of the first estimates \tilde{x}(t), \tilde{y}(t) and \tilde{z}(t) and provides as output the respective one of the modified similarity vectors a′ₓ(t), a′_{y}(t) and a′_{z}(t).

In an embodiment, after obtaining the modified similarity vectors a′ₓ(t), a′_{y}(t) and a′_{z}(t), a weighted superposition of the modified similarity vectors a′ₓ(t), a′_{y}(t) and a′_{z}(t) is performed using the codebooks X^{T}, Y^{T} and Z^{T} stored in memories 108x, 108y, and 108z, respectively. This may be performed by the following matrix vector multiplications: Xa′ₓ(t)), Ya′_{y}(t)) and Za′_{z}(t). The resulting hypervectors Xa′ₓ(t)), Ya′_{y}(t)) and Za′_{z}(t) are fed to the sign units 110x, 110y and 110z, respectively. This results in obtaining the following: \hat{x}(t+1)=sign(Xa′ₓ(t)), ŷ(t+1)=sign(Ya′_{y}(t)) and \hat{z}(t+1)=sign(Za′_{z}(t)), respectively, which subsequently results in obtaining the estimate of the hypervectors \hat{x}(t+1), ŷ(t+1) and \hat{z}(t+1) respectively for the next iteration t+1. This enables the superposition step of the iterative process. In an embodiment, for each concept of the concepts, the superposition step receives as input the respective one of the modified similarity vectors a′ₓ(t), a′_{y}(t) and a′_{z}(t) and provides as an output the respective one of the hypervectors \hat{x}(t+1), ŷ(t+1) and \hat{z}(t+1). Hence, the estimate of the hypervectors representing the set of concepts, respectively, can be defined according to at least one embodiment of the present invention as follows \hat{x}(t+1)=g(Xkact(X^{T} (s⊙ŷ(t)⊙\hat{z}(t)))), ŷ(t+1)=g(Ykact(Y^{T} (s⊙\hat{x}(t)⊙\hat{z}(t)))) and \hat{z}(t+1)=g(Zkact(Z^{T} (s⊙\hat{x}(t)⊙\hat{z}(t)))), where g is the activation function, such as a sign function.

In an embodiment, the iterative process may stop if a stopping criterion is fulfilled. The stopping criterion may, for example, require that \hat{x}(t+1)=\hat{x}(t), ŷ(t+1)=ŷ(t) and 2(t+1) =\tilde{z}(t) or that a maximum number of iterations is reached.

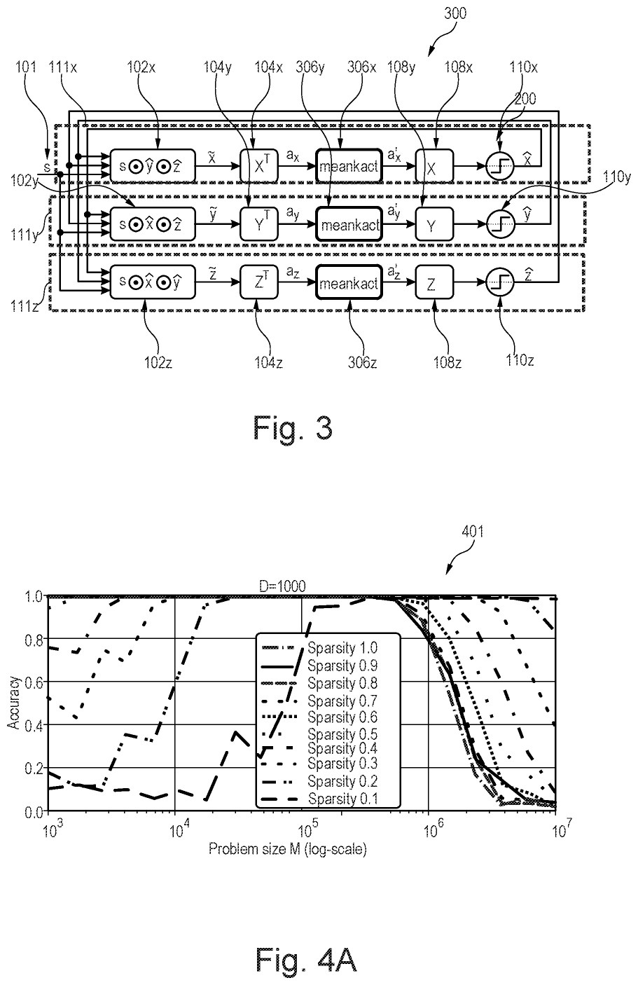

FIG. 2 is a functional block diagram of a resonator network computing environment, generally designated 200, in accordance with at least one embodiment of the present invention. Resonator network computing environment 200 is similar to resonator network computing environment 100 of FIG. 1, and provides an example of the activation function topkact. Resonator network computing system 200 includes activation units 206x, 206y and 206z for each of the three concepts that implement the activation function topkact according to at least one embodiment of the present invention. In particular, the activation function topkact only activates the top K values in each of the similarity vectors aₓ(t), a_{y}(t) and a_{z}(t), where K<<Mᵢ, where i=x, y or z, and sets the rest of elements to zero to produce a′ₓ(t), a′_{y}(t) and a′_{z}(t), respectively. In an embodiment, the top K values of a similarity vector are obtained by sorting absolute values of the similarity vector. The resulting vectors a′ₓ(t), a′_{y}(t) and a′_{z}(t) keep the sign of the values (e.g., if an element has a negative value of −5, it may be ranked first if all other values are below 4, because its absolute value is 5; however, the resulting sparsified vector a′ may keep the sign i.e., the value −5). The present method when using this top-K sparsification may be referred to as the top-K sparsification method. This method may result in doing only K vector multiplication-addition operations instead of Mᵢ operations.

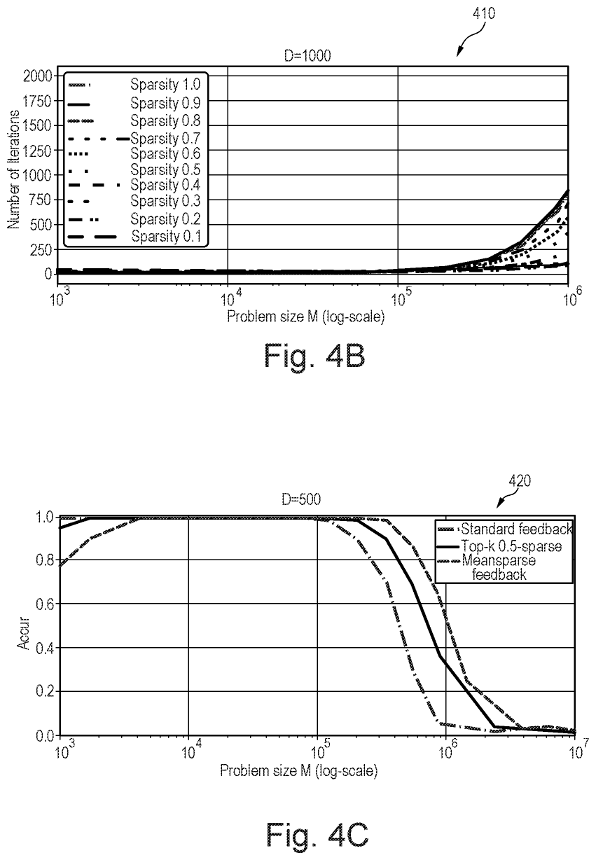

FIG. 3 is a functional block diagram of a resonator network computing environment, generally designated 300, in accordance with at least one embodiment of the present invention. Resonator network computing environment 300 is similar to resonator network computing environment 100 of FIG. 1, and provides an example activation function meankact. Resonator network computing environment 300 includes activation units 306x, 306y and 306z for each of the three concepts that implement the activation function meankact according to at least one embodiment of the present invention. In an embodiment, the activation function meankact activates each element in each of the similarity vectors aₓ(t), a_{y}(t) and a_{z}(t) only if the absolute value of said element is larger than the mean of all absolute elements of the respective similarity vector. The present method when using this activation function may be referred to as a mean-based thresholding method. The mean-based thresholding method may be advantageous compared to the top- K sparsification method because the top- K sparsification method may be required to sort |aₓ(t)|=Mₓ elements, |a_{y}(t)|=M_{y} elements and |a_{z}(t)|=M_{z} elements. The mean-based thresholding method may reduce the computational complexity of the sorting by activating elements in the similarity vectors only if larger than the mean. This mean-based thresholding may result in ˜50% of values activated in the similarity vectors.

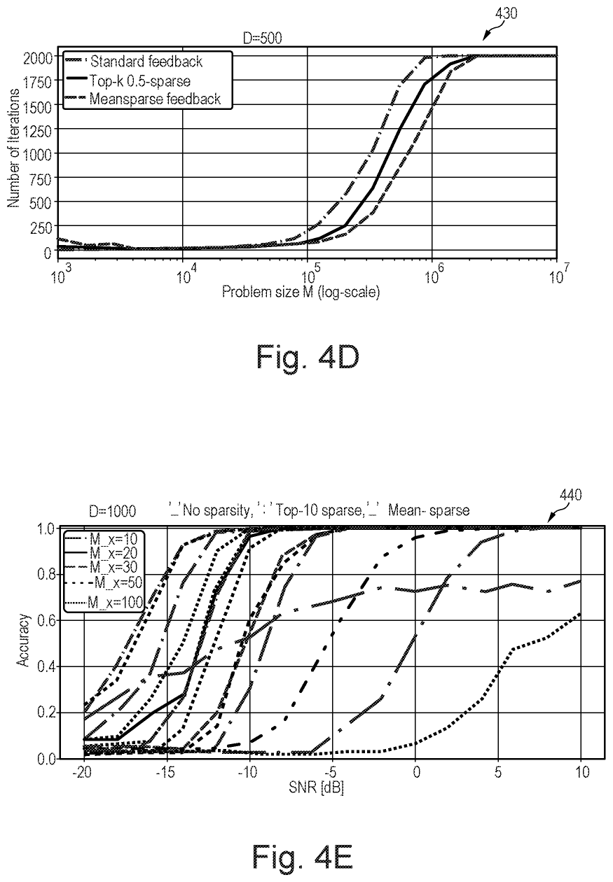

FIG. 4A is a graph illustrating the accuracy of a resonator network using a top-k sparsification method, generally designated 401, in accordance with at least one embodiment of the present invention. Specifically, graph 401 depicts the accuracy obtained by resonator network computing environment 200 based on the top-K sparsification method as a function of different values K and different sizes M of the search space, where where M is increased by >10× at fixed D and equal accuracy, where D=1000 is the size of the code hypervector. As illustrated by graph 401, the top-K sparsification method may increase solvable problem size by at least one order of magnitude.

FIG. 4B is a graph illustrating the number of iterations required by a resonator network using a top-k sparsification method, generally designated 410, in accordance with at least one embodiment of the present invention. Specifically, graph 410 depicts the number of iterations required by resonator network computing environment 200 based on the top-K sparsification method as a function of different values K and different sizes M of the search space, where where M is increased by >10× at fixed D and equal accuracy, where D=1000 is the size of the code hypervector. As illustrated by graph 410, the top-K sparsification method may increase solvable problem size by at least one order of magnitude.

FIG. 4C is a graph illustrating the accuracy of a resonator network using a mean-based thresholding method, generally designated 420, in accordance with at least one embodiment of the present invention. Specifically, graph 420 depicts the accuracy obtained by resonator network computing environment 300 based on the mean-based thresholding method as a function of difference sizes M of the search space for D=500, which is the size of the code hypervector. This is in comparison with the results of the top-K sparsification method and a standard method. As illustrated by graph 420, the mean-based thresholding method may be as good, if not better, than the top-K sparsification method.

FIG. 4D is a graph illustrating the number of iterations required by a resonator network using a mean-based thresholding method, generally designated 430, in accordance with at least one embodiment of the present invention. Specifically, graph 430 depicts the number of iterations required by resonator network computing environment 300 based on the based on the mean-based thresholding method as a function of difference sizes M of the search space for D=500 which is the size of the code hypervector. This is in comparison with the results of the top-K sparsification method and a standard method. As illustrated by graph 430, the mean-based thresholding method may be as good, if not better, than the top-K sparsification method.

FIG. 4E is a graph illustrating noise resiliency and accuracy of: a resonator network using a top-k sparsification method, a resonator using a mean-based thresholding method, and a resonator network that does not use a sparsification method, generally designated 440, in accordance with at least one embodiment of the present invention. As depicted by FIG. 4E, the sparsification methods also improve noise resiliency, especially for solving larger problem sizes. For instance, with Mₓ=50, the sparsification leads to the same accuracy of an original resonator (with no sparsity) while operating with 10 dB lower SNR. FIG. 4E further depicts the accuracy obtained with the top-K sparsification method, with the mean-based thresholding method, and with a method that does not use sparsification for different sizes of Mₓ and hypervectors of size D=1000.

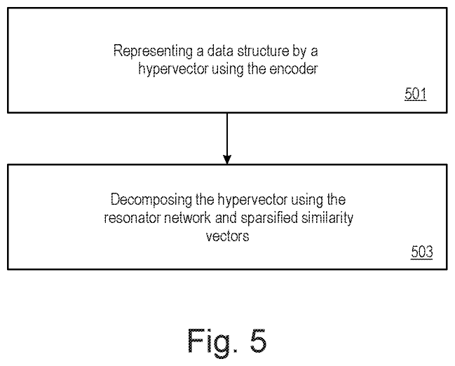

FIG. 5 is a flow chart diagram depicting operations steps for factorizing hypervectors in a resonator network accordance with at least one embodiment of the present invention. At step 501, a first data structure is represented by a hypervector s using an encoder such as a VSA based encoder. The first data structure may, for example, be a query image representing a visual scene. In an embodiment, the encoder is a feed-forward neural network that is trained to produce the hypervector s as a compound hypervector describing the input visual image. The image may comprise colored MNIST digits. The components of the image may be the color, shape, vertical and horizontal locations of the letters in the image. The encoder may, for example, be configured to compute a hypervector for each letter in the image by multiplying the related quasi-orthogonal hypervectors drawn from four fixed codebooks of four concepts: color codebook (with 7 possible colors), shape codebook (with 26 possible shapes), vertical codebook (with 50 possible locations), and horizontal codebook (with 50 possible locations). The product vectors for every letter are added (component-wise) to produce the hypervector s describing the whole image.

At step 503, the hypervector s may be decomposed using the resonator network, wherein the resonator network is adapted such that the similarity step of the iterative process is adapted so that the similarity vector is sparsified before the superposition step of the iterative process is performed on the sparsified similarity vector. Following the example of the visual image, step 503 may be performed using a resonator network system similar to resonator network computing environment 100, with the difference that an additional processing line may be added to resonator network computing system 100 so that the four processing lines may be used to find the hypervectors for the four concepts respectively.

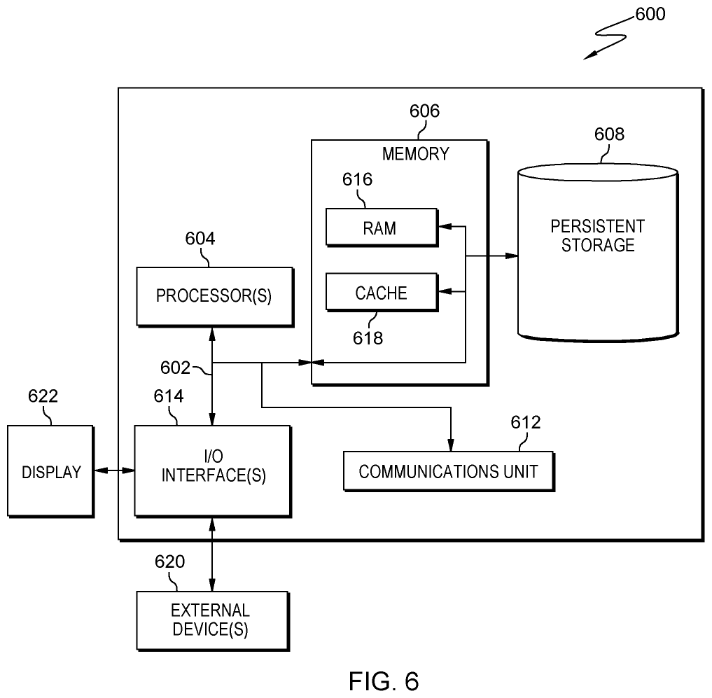

FIG. 6 is a block diagram depicting components of a computing device, generally designated 600, suitable for performing a method for factorizing hypervectors in a resonator network in accordance with at least one embodiment of the present invention. Computing device 600 includes one or more processor(s) 604 (including one or more computer processors), communications fabric 602, memory 606 including, RAM 616 and cache 618, persistent storage 608, communications unit 612, I/O interface(s) 614, display 622, and external device(s) 620. It should be appreciated that FIG. 6 provides only an illustration of one embodiment and does not imply any limitations with regard to the environments in which different embodiments may be implemented. Many modifications to the depicted environment may be made.

As depicted, computing device 600 operates over communications fabric 602, which provides communications between computer processor(s) 604, memory 606, persistent storage 608, communications unit 612, and input/output (I/O) interface(s) 614. Communications fabric 602 can be implemented with any architecture suitable for passing data or control information between processor(s) 604 (e.g., microprocessors, communications processors, and network processors), memory 606, external device(s) 620, and any other hardware components within a system. For example, communications fabric 602 can be implemented with one or more buses.

Memory 606 and persistent storage 608 are computer readable storage media. In the depicted embodiment, memory 606 includes random-access memory (RAM) 616 and cache 618. In general, memory 606 can include any suitable volatile or non-volatile computer readable storage media.

Program instructions for performing a method for factorizing hypervectors in a resonator network in accordance with at least one embodiment of the present invention can be stored in persistent storage 608, or more generally, any computer readable storage media, for execution by one or more of the respective computer processor(s) 604 via one or more memories of memory 606. Persistent storage 608 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 612, in these examples, provides for communications with other data processing systems or devices. In these examples, communications unit 612 can include one or more network interface cards. Communications unit 612 may provide communications through the use of either or both physical and wireless communications links. In the context of some embodiments of the present invention, the source of the various input data may be physically remote to computing device 600 such that the input data may be received, and the output similarly transmitted via communications unit 612.

I/O interface(s) 614 allows for input and output of data with other devices that may operate in conjunction with computing device 600. For example, I/O interface(s) 614 may provide a connection to external device(s) 620, which may be as a keyboard, keypad, a touch screen, or other suitable input devices. External device(s) 620 can also include portable computer readable storage media, for example thumb drives, portable optical or magnetic disks, and memory cards. Software and data used to practice embodiments of the present invention can be stored on such portable computer readable storage media and may be loaded onto persistent storage 608 via I/O interface(s) 614. I/O interface(s) 614 also can similarly connect to display 622. Display 622 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

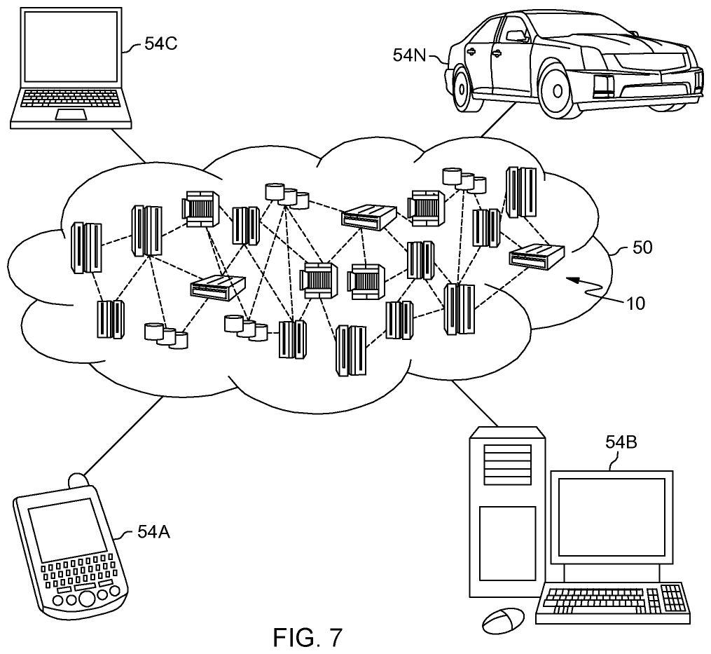

FIG. 7 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

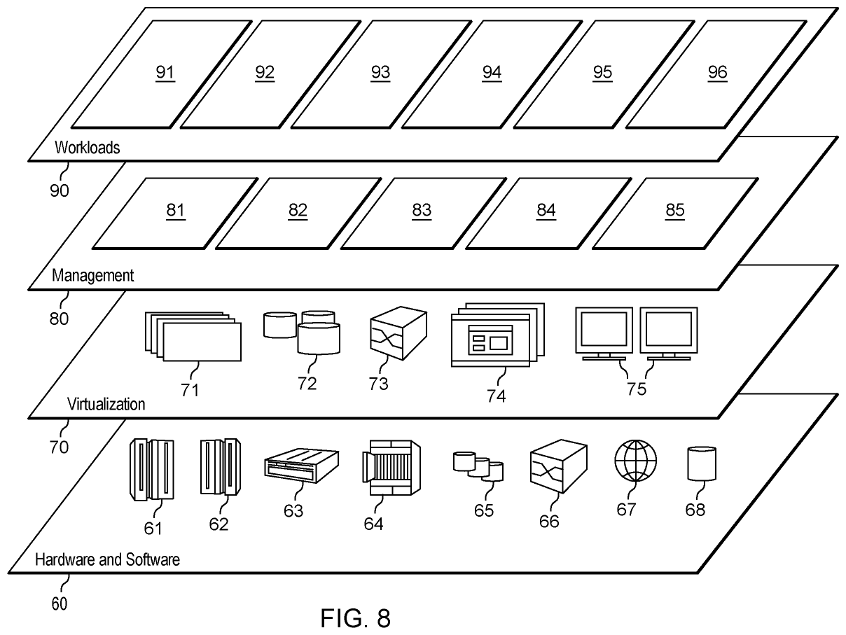

FIG. 8 is block diagram depicting a set of functional abstraction model layers provided by cloud computing environment 50 depicted in FIG. 7 in accordance with at least one embodiment of the present invention. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and factorizing hypervectors in a resonator network 96.

What is claimed is:

1. A computer-implemented method for factorizing hypervectors in a resonator network, comprising:
receiving an input hypervector representing a data structure; and
performing an iterative process for each concept in a set of concepts associated with the data structure in order to factorize the input hypervector into a plurality of individual hypervectors representing the set of concepts, respectively, wherein the iterative process includes:
generating a first estimate of an individual hypervector representing a concept in the set of concepts;
generating a similarity vector indicating a similarity of the estimate of the individual hypervector representing the concept with each candidate attribute hypervector of a plurality of candidate attribute hypervectors representing an attribute associated with the concept; and
generating a second estimate of the individual hypervector representing the concept in the set of concepts, wherein the second estimate of the individual hypervector is generated based, at least in part, on a linear combination of the plurality of candidate attribute hypervectors and performing a non-linear function on the linear combination of the plurality of candidate attribute hypervectors.

2. The computer-implemented method of claim 2, further comprising sparsifying the similarity vector prior to generating the second estimate of the individual hypervector representing the concept in the set of concepts, wherein sparsifying the similarity vector includes:
activating a first portion of a plurality of elements of the similarity vector; and
deactivating a second portion of the plurality of elements of the similarity vector based on setting the second portion of the plurality of elements of the similarity vector to a defined value.

3. The computer-implemented method of claim 3, wherein the first portion of activated elements of the similarity vector are the top-K elements of a plurality of similarity vectors, and wherein K is a configurable parameter that is smaller than a total number of elements of the similarity vector by a defined number.

4. The computer-implemented method of claim 2, wherein the first portion of activated elements of the similarity vector are elements having absolute values higher than a defined threshold.

5. The computer-implemented method of claim 4, wherein the defined threshold is the mean of the absolute values of the plurality of elements of the similarly vector.

6. The computer-implemented method of claim 1, wherein the non-linear function is a sign function.

7. The computer-implemented method of claim 1, wherein the data structure is represented by the first hypervector in a vector space via an encoder, wherein the vector space is defined by a set of matrices that encode the set of concepts, respectively, and wherein the set of matrices include the plurality of candidate attribute hypervectors representing attributes of the plurality of concepts, respectively.

8. The computer-implemented method of claim 7, wherein the encoder is a feed forward neural network.

9. The computer-implemented method of claim 1, wherein the iterative process is performed in a resonator network.

10. The computer-implemented method of claim 1, wherein the data structure is an image, the plurality of candidate attribute hypervectors representing a concept of color, a concept of shape, a concept of vertical positioning, and a concept of horizontal positioning.

11. A computer program product for factorizing hypervectors in a resonator network, the computer program product comprising one or more computer readable storage media and program instructions stored on the one or more computer readable storage media, the program instructions including instructions to:
receive an input hypervector representing a data structure; and
perform an iterative process for each concept in a set of concepts associated with the data structure in order to factorize the input hypervector into a plurality of individual hypervectors representing the set of concepts, respectively, wherein the iterative process includes:
generating a first estimate of an individual hypervector representing a concept in the set of concepts;
generating a similarity vector indicating a similarity of the estimate of the individual hypervector representing the concept with each candidate attribute hypervector of a plurality of candidate attribute hypervectors representing an attribute associated with the concept; and
generating a second estimate of the individual hypervector representing the concept in the set of concepts, wherein the second estimate of the individual hypervector is generated based, at least in part, on a linear combination of the plurality of candidate attribute hypervectors and performing a non-linear function on the linear combination of the plurality of candidate attribute hypervectors.

12. A computer system for factorizing hypervectors in a resonator network, the computer system comprising:
one or more computer processors;
one or more computer readable storage media;
computer program instructions, the computer program instructions being stored on the one or more computer readable storage media for execution by the one or more computer processors; and
the computer program instructions including instructions to:
receive an input hypervector representing a data structure; and
perform an iterative process for each concept in a set of concepts associated with the data structure in order to factorize the input hypervector into a plurality of individual hypervectors representing the set of concepts, respectively, wherein the iterative process includes:
generating a first estimate of an individual hypervector representing a concept in the set of concepts;
generating a similarity vector indicating a similarity of the estimate of the individual hypervector representing the concept with each candidate attribute hypervector of a plurality of candidate attribute hypervectors representing an attribute associated with the concept; and
generating a second estimate of the individual hypervector representing the concept in the set of concepts, wherein the second estimate of the individual hypervector is generated based, at least in part, on a linear combination of the plurality of candidate attribute hypervectors and performing a non-linear function on the linear combination of the plurality of candidate attribute hypervectors.

13. The computer system of claim 12, further comprising instructions to sparsify the similarity vector prior to generating the second estimate of the individual hypervector representing the concept in the set of concepts, wherein the instructions to sparsify the similarity vector includes instructions to:
activate a first portion of a plurality of elements of the similarity vector; and
deactivate a second portion of the plurality of elements of the similarity vector based on setting the second portion of the plurality of elements of the similarity vector to a defined value.

14. The computer system of claim 13, wherein the first portion of activated elements of the similarity vector are the top-K elements of a plurality of similarity vectors, and wherein K is a configurable parameter that is smaller than a total number of elements of the similarity vector by a defined number.

15. The computer system of claim 13, wherein the first portion of activated elements of the similarity vector are elements having absolute values higher than a defined threshold.

16. The computer system of claim 14, wherein the defined threshold is the mean of the absolute values of the plurality of elements of the similarly vector.

17. The computer system of claim 12, wherein the non-linear function is a sign function.

18. The computer system of claim 12, wherein the data structure is represented by the first hypervector in a vector space via an encoder, wherein the vector space is defined by a set of matrices that encode the set of concepts, respectively, and wherein the set of matrices include the plurality of candidate attribute hypervectors representing attributes of the plurality of concepts, respectively.

19. The computer system of claim 18, wherein the encoder is a feed forward neural network.

20. The computer system of claim 12, wherein the iterative process is performed in a resonator network.
